(19) United States
(12) Patent Application Publication
(10) Pub. No.: US 2007/0089823 A1
(43) Pub. Date: Apr. 26, 2007

(54) Tire chain

(76) Inventor: Agyd Pengg, Velden (AT)

Correspondence Address: RATNERPRESTIA, P O BOX 980, VALLEY FORGE, PA, 19482-0980, US

(21) Appl. No.: 11/546,732

(22) Filed: Oct. 12, 2006

(30) Foreign Application Priority Data
Oct. 12, 2005 (AT) A 1662/2005
Dec. 14, 2005 (AT) A 1998/2005
Dec. 27, 2005 (AT) A 2080/2005
Jul. 5, 2006 (AT) A 1151/2006

(51) Int. Cl. B60C 27/00

(52) U.S. Cl. 152/231

(57) ABSTRACT

A tire chain for a vehicle is provided. The tire chain has an outer side strand that is in contact with an outer side flank of a vehicle tire in the mounted state and an inner side strand that is in contact with an inner side flank of the vehicle tire in the mounted state. A chain net is in contact with the tread of the vehicle tire in the mounted state and is arranged between the outer side strand and the inner side strand in the mounted state. The inner side strand is of a stretchable design. The inner side strand has an outer part enveloping an inner part, and the outer part and the inner part are of different stretchabilities.

### CROSS-REFERENCE TO RELATED APPLICATIONS

This application is a Country Equivalent Application of Austrian Application No. A 1662/2005, filed Oct. 12, 2005; Austrian Application No. A 1998/2005, filed Dec. 14, 2005; Austrian Application No. A 2080/2005, filed Dec. 27, 2005; and Austrian Application No. A 1151/2006, filed Jul. 05, 2006.

### FIELD OF THE INVENTION

The present invention pertains to a tire chain for a vehicle, the said tire chain having an outer side strand that is in contact with an outer side flank of a vehicle tire in the mounted state and an inner side strand that is in contact with an inner side flank of the vehicle tire in the mounted state, a chain net that is in contact with the tread of the vehicle tire being arranged between the outer side strand and the inner side strand in the mounted state, and the inner side strand having a stretchable design.

### BACKGROUND OF THE INVENTION

A tire chain, which has an inner side strand and an outer side strand, which are designed as a rubber ring each, is known from FR 2561589 A1. Cross-shaped elements, which come to lie on the tread of a tire, are arranged between the inner side strand and the outer side strand. The tire chain can be pulled onto the vehicle tire by stretching the inner side strand. The drawback of the prior-art embodiment is, above all, that the use of a very thick rubber ring makes mounting rather difficult or even impossible, whereas the use of a rubber ring that can be pulled onto the tire with little effort leads to poor hold of the tire chain on the vehicle tire.

### BRIEF SUMMARY OF THE INVENTION

The present invention provides a tire chain that can be mounted as simply as possible and with which optimal hold on the vehicle tire is guaranteed at the same time.

This is accomplished according to the present invention with a tire chain of the type mentioned in the introduction by the inner side strand having an inner part and an outer part enveloping same, the said outer part and the said inner part having different stretchabilities.

It is possible with the solution according to the present invention to guarantee both simple mounting of the tire chain and very good hold of the mounted chain on a vehicle tire.

To guarantee especially good mounting properties and good hold on the tire, it is advantageous if the outer part of the inner side strand is designed as a closed, tube-like ring designed as a ring that is rubber-elastic at least in some sections or can be connected into such a ring.

Provisions are made in an advantageous variant of the present invention for the inner part to have two ends that are displaceable in relation to one another in the longitudinal direction of the inner part. The diameter of the inner part can be automatically reduced in this embodiment because the inner part can be displaced in itself by the contraction of the outer part. In return, the diameter of the inner part can be reduced during the mounting by pulling apart.

According to another advantageous embodiment of the present invention, the inner part is designed as a spring that is stable against pulling. Due to the stability against pulling, unintended stretching of the tire chain can be prevented from occurring.

A variant of the present invention, which can be embodied in a simple manner, provides for eyes to be provided at the two ends of the inner part, through which eyes free end sections of the inner part that are displaceable in relation to one another can be led.

To guarantee good fixation of the inner part after mounting, the inner side strand may have a ratchet, by means of which end sections of the inner part, which are freely displaceable in relation to one another, can be fixed in relation to one another. According to one variant, the ratchet can be actuated by a user.

The comfort of use can, however, be increased by the ratchet having a centrifugal clamping mechanism, so that rolling of the tire leads to fixation of the free end sections.

Provisions are made in another variant of the present invention for the inner part to be rubber-elastic at least in some sections. The inner part is preferably designed as a closed ring. This has the advantage that in an embodiment in which the outer part has two free ends, which are connected to a part of a detachable, self-closing closure each, which are in turn connected to the inner part of the inner side strand, the closing parts are pulled in relation to one another. Thus, automatic closure of the inner side strand ISS is guaranteed on the inner side of the vehicle tire after the inner side strand is pulled onto the vehicle tire.

The present invention also provides in addition to the inner side strand, at least one additional elastic strand, which is likewise in contact with the inner side flank of the vehicle tire in the mounted state and by the at least one additional strand being preferably designed in a ring-shaped manner. A plurality of rubber rings of a smaller thickness, which are pulled onto the tire one after another, can be used instead of a thick rubber ring.

Simple and reliable tensioning of the tire chain can be achieved by the inner side strand being connected directly to the chain net by means of fastening means, so that tensioning forces caused by the inner side strand are introduced directly into the chain net.

### BRIEF DESCRIPTION OF THE DRAWINGS

The present invention as well as additional advantages will be explained in more detail below on the basis of some nonlimiting exemplary embodiments, which are shown in the drawings. In the drawings,

FIG. 1 shows a tire chain according to the present invention in a perspective view;

FIG. 2 shows a perspective view of the inner side of a tire with a tire chain according to the present invention in the mounted state;

FIG. 3 shows a perspective view of the outer side of the tire from FIG. 2 with the tire chain according to the present invention from FIG. 2;

FIG. 4 shows a perspective view of the tread of the tire from FIG. 2 and FIG. 3 with the tire chain according to the present invention from FIG. 2 and FIG. 3; and

FIGS. 5-14 show different variants of inner side strands.

### DETAILED DESCRIPTION OF THE INVENTION

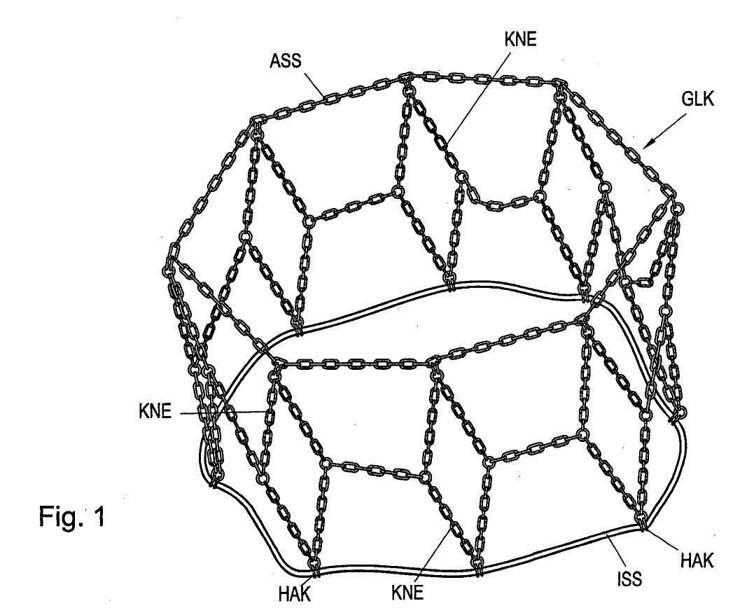

According to FIG. 1, a tire chain GLK or snow chain according to the present invention for a vehicle has an outer side strand ASS designed as a chain KNE and an inner side strand ISS. A chain net KNE is arranged between the outer side strand ASS and the inner side strand ISS, the inner side strand ISS being designed as a stretchable strand. More precisely, the inner side strand ISS can be stretched in the direction of its longitudinal axis, as a result of which the length of the inner side strand ISS can be changed. As a result, the mounting of the tire chain on a vehicle tire is made easier. To guarantee good hold of the tire chain in the mounted state, the inner side strand ISS is designed, furthermore, as an elastic strand.

The inner side strand ISS can be connected directly to the chain net KNE by means of fastening means, for example, by means of hooks HAK or plastic clips, not shown here, so that the tensioning forces generated by the inner side strand ISS are introduced directly into the chain net KNE. Furthermore, the inner side strand may be provided with holes, through which the hooks are led. As an alternative, the inner side strand ISS may also be contained in a textile band/fabric. Holes may be provided in this textile band in order to receive the hooks HAK or similar fixing possibilities for the chain net KNE. Very good seating on a tire can thus be achieved.

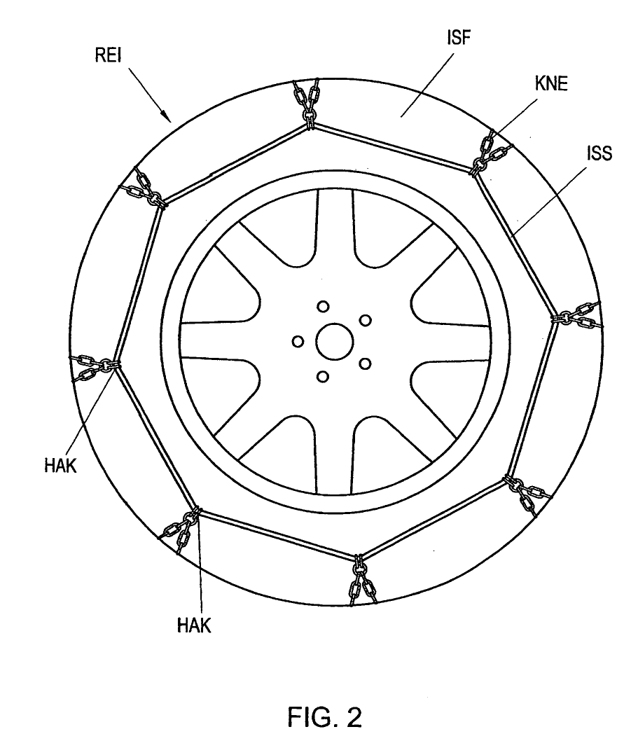

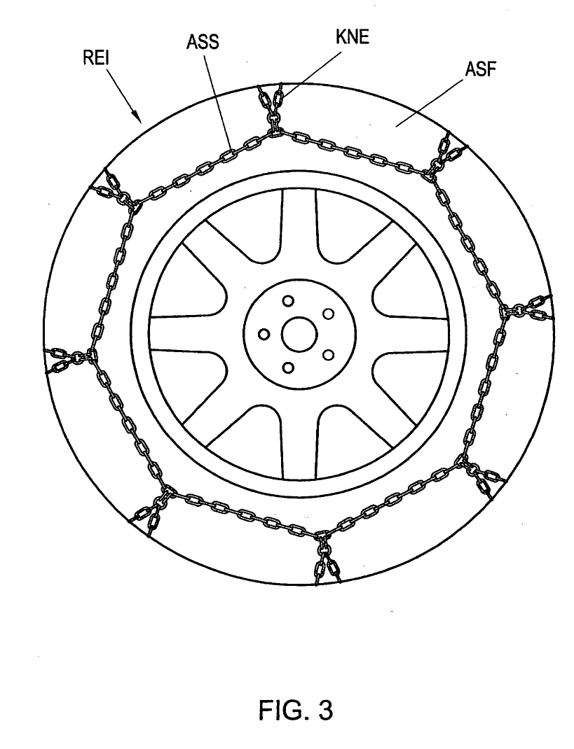

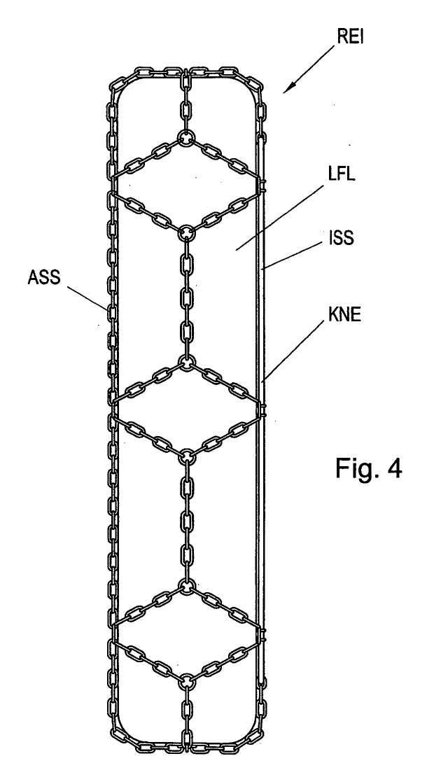

For mounting, the tire chain GLK can be pulled simply onto a tire designated by “REI” in FIGS. 2-4. The inner side strand ISS closed into a ring is now pulled from the outside of the tire over the tire tread, which is designated by “LFL” in FIG. 4, which can be brought about in a very simple manner because of the stretchability of the inner side strand. Depending on the properties of the substrate and accessibility, the inner side strand ISS can be forced partly or fully between the substrate and the tread of the tire REI at the contact surface between the tire REI and the substrate. After pulling the tire chain GLK onto the tire, it is possible to simply start driving, without having to take any further mounting measures. Due to the pulling forces of the inner side strand ISS, the section of the inner side strand that is forced between the tread and the substrate in the area of the contact surface of the tire REI is pulled automatically onto the inner side of the tire REI, so that optimal seating of the tire chain is guaranteed. To remove the tire chain GLK, the inner side strand ISS is again stretched somewhat and pulled from the inner side of the tire REI onto the front side of the tire, i.e., it is pulled forward from behind onto the tread.

According to FIG. 2, the inner side strand ISS is in contact with an inner side flank ISF of the vehicle tire REI in the mounted state of the tire chain GLK. The outer side strand ASS may also be interrupted in order to be able to be closed with hooks. Instead of the hooks, it is also possible to connect the ends of the outer side strand ASS by means of a ratchet system in order to achieve even better tensioning of the tire chain GLK.

As an alternative, the outer side strand ASS may also be replaced with a strip of rubber or with a strand designed in the same manner as the inner side strand ISS. However, other embodiments of the outer side strand ASS are also possible, in principle, for example, it may be designed as a cable, especially as a steel or textile cable or even as a textile band, especially as a tube-like textile band, inside of which extends a rubber strand as a tensioning element.

As is shown in FIG. 3, the outer side strand ASS is in contact with the outer side flank AFL of the tire REI in the mounted state. The outer side strand ASS is designed as a continuous chain in the embodiment being shown here. However, it is also possible for the outer side strand ASS to be designed as a split chain and closed by a tensioning element, not shown here.

According to FIG. 4, the chain net KNE is in contact with the tread LFL of the tire REI in the mounted state. The chain net KNE is directly connected to the inner side strand ISS by means of the hooks HAK. The outer side strand ASS can also be connected to the chain net KNE by means of hooks, just like the inner side strand.

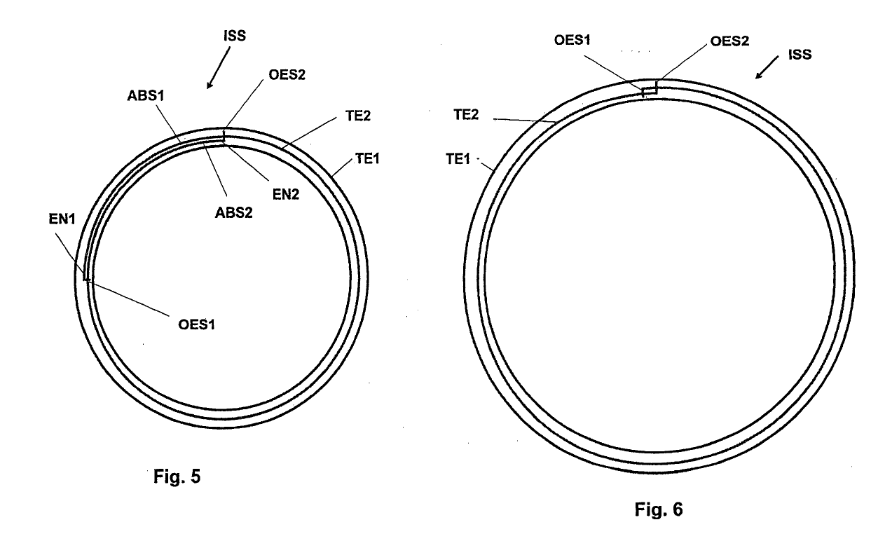

As is apparent from FIGS. 5 and 6, the inner side strand ISS has, according to the present invention, an inner part TE2 and an outer part TE1 enveloping same, the outer part TE1 and the inner part TE2 being of different stretchabilities. The outer part TE1 of the inner side strand ISS is designed as a closed, tube-like rubber ring. The inner part TE2 is designed as a spring that is stable against pulling and has two ends EN1, EN2, which are displaceable in relation to one another in the longitudinal direction of the inner part TE2. Eyes OES1, OES2, through which free end sections ABS1, ABS2 of the inner part TE2 are led, may be provided at the two ends EN1, EN2 of the inner part TE2. By displacing the ends EN1, EN2 in relation to one another, the circumference of the inner part TE2 can be pulled together. This is shown in FIG. 5. The outer part TE1 can be stretched and the circumference of the inner part TE2 can be enlarged by the action of an external force, so that it becomes possible to pull the inner side strand ISS onto a tire.

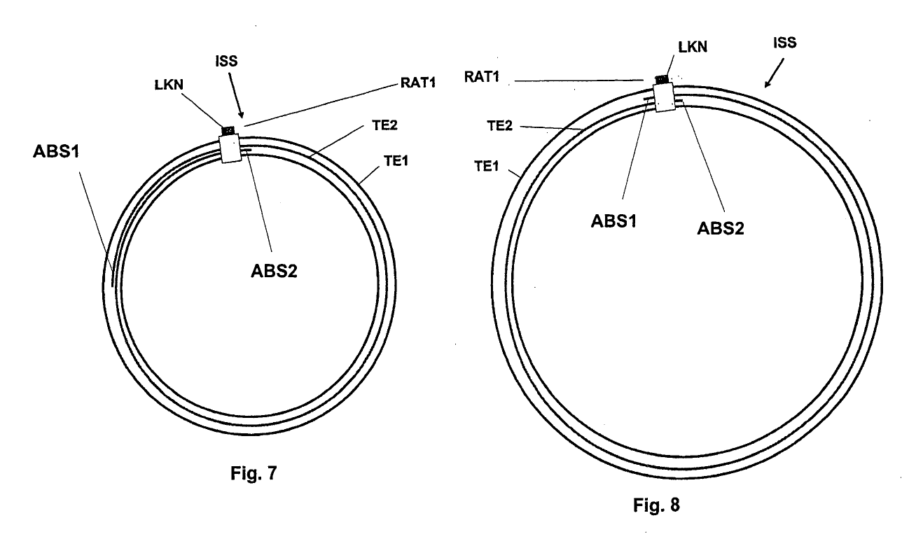

According to FIGS. 7 and 8, the inner side strand ISS may have a ratchet RAT1, RAT2, by means of which free end sections ABS1, ABS2 of the inner part TE2, which end sections can be displaced in relation to one another, can be fixed. To make possible the release of the ratchet RAT1 and thus the release of the end sections ABS1, ABS2 of the inner part, an actuating member, for example, in the form of a release button LKN, is provided. FIG. 7 shows the inner side strand ISS in the mounted state with the ratchet RAT1 fixed. FIG. 8 shows the inner side strand ISS with the ratchet released and with the outer part TE1 stretched.

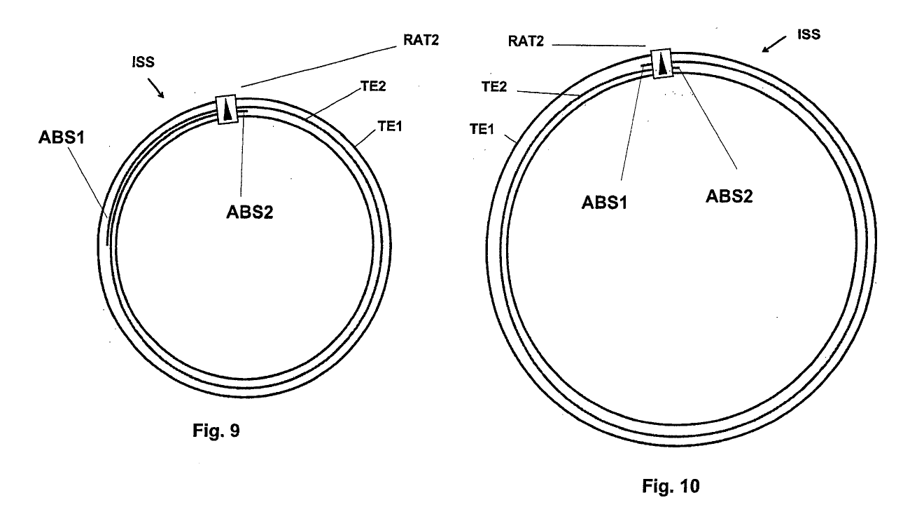

As is shown in FIGS. 9 and 10, the ratchet RAT2 may have a centrifugal force clamping mechanism, so that rolling of the vehicle tire REI leads to fixation of the free end sections ABS1, ABS2. Manual release of the ratchet RAT2 is not necessary in this case. FIG. 9 shows the inner side strand ISS in the mounted state with the ratchet RAT2 fixed and the outer part TE1 pulled together. FIG. 10 shows the inner side strand ISS with the ratchet RAT2 released and the outer part TE1 stretched.

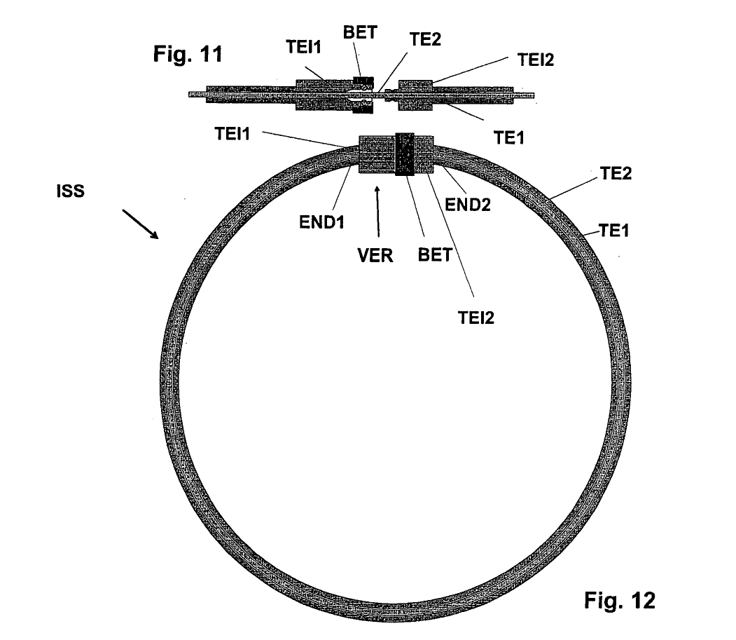

According to the embodiment of the present invention shown in FIGS. 11 and 12, the inner part TE2 can likewise be designed as a rubber-elastic and ring-shaped part. The outer part TE1 has two free ends END1, END2 here, which are connected to a part TEI1, TEI2 each of a detachable, self-closing closure VER. The two parts TEI1, TEI2 of the closure VER are likewise connected to the inner part TE2 of the inner side strand ISS. Due to the elastic restoring forces of the inner part TE2, the two closure parts TEI1 and TEI2 are pulled in relation to one another after stretching of the inner side strand ISS and snap into one another. The closure VER can again be released by means of an actuating member BET.

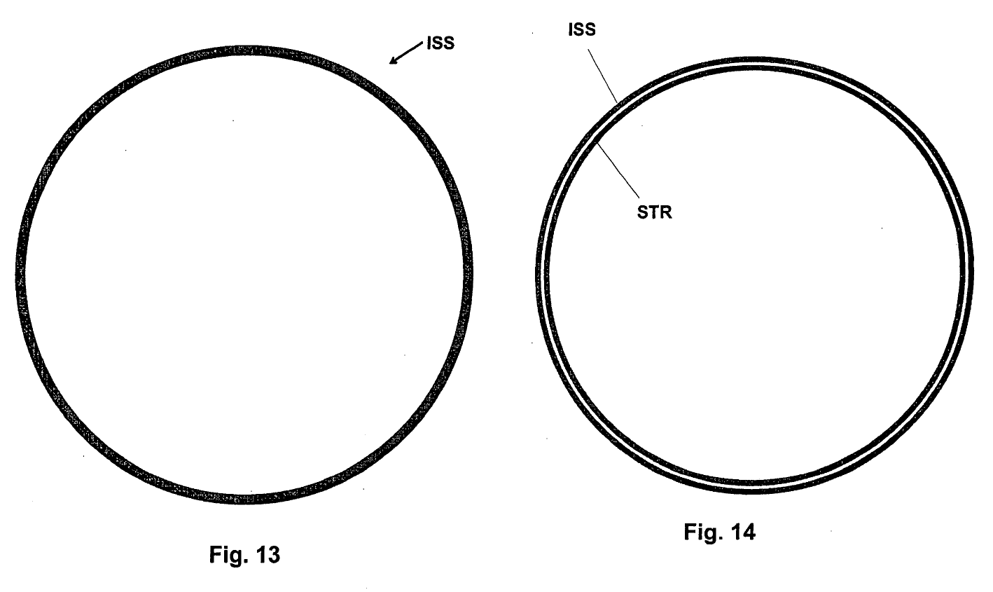

According to FIG. 14, one or more elastic strands STR of an annular design, which are likewise in contact with the inner side flank ASF of the vehicle tire in the mounted state and can be pulled onto the vehicle tire one after another for mounting, may be provided instead of an inner side strand ISS shown in FIG. 13 in the form of a strip of rubber in addition to this.

The inner side strand ISS is dimensioned in all embodiments such that it fits preset tire dimensions in order to guarantee optimal hold on the tire.

It is, of course, also possible to use other materials and designs not mentioned here, with which the properties of the inner side strand ISS according to the present invention can be obtained, besides the above-mentioned exemplary embodiments.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. Tire A tire chain for a vehicle, wherein the said tire chain has an outer side strand that is in contact with an outer side flank of a vehicle tire in the mounted state and an inner side strand that is in contact with an inner side flank of the vehicle tire in the mounted state, a chain net being arranged between the outer side strand and the inner side strand in the mounted state on the tread of the vehicle tire, and the inner side strand having a stretchable design, wherein the inner side strand has an inner part and an outer part enveloping same, the outer part and the inner part having different stretchabilities.

2. The tire chain in accordance with claim 1, wherein the outer part of the inner side strand is designed as a closed, tube-like ring designed as a ring that is rubber-elastic at least in some sections or can be connected into such a ring.

3. The tire chain in accordance with claim 1, wherein the inner part has two ends that are displaceable in relation to one another in the longitudinal direction of the inner part.

4. The tire chain in accordance with claim 1, wherein the inner part is designed as a spring that is stable against pulling.

5. The tire chain in accordance with claim 4, wherein eyes, through which said free end sections of the inner part, which can be displaced in relation to one another, are led, are provided at the two ends of the said inner parts.

6. The tire chain in accordance with claim 1, wherein the inner side strand has a ratchet, by means of which said free end sections of the inner part, which said end sections are displaceable in relation to one another, can be fixed.

7. The tire chain in accordance with claim 6, wherein the ratchet can be actuated by a user.

8. The tire chain in accordance with claim 6, wherein the ratchet has a centrifugal force clamping mechanism, so that rolling of the vehicle tire leads to fixation of the free end sections.

9. The tire chain in accordance with claim 2, wherein the inner part has a rubber-elastic design at least in some sections.

10. The tire chain in accordance with claim 9, wherein the inner part is designed as a closed ring.

11. The tire chain in accordance with claim 9, wherein the outer part has two free ends, which are connected to a part each of a detachable, self-closing closure, the parts being connected to the inner part of the inner side strand and being pulled in relation to one another.

12. A tire chain for a vehicle, the tire chain having an outer side strand that is in contact with an outer side flank of a vehicle tire in the mounted state and an inner side strand that is in contact with an inner side flank of the vehicle tire in the mounted state, a chain net, which is in contact with the tread of the vehicle tire in the mounted state, being arranged between the outer side strand and the inner side strand, the inner side strand having a stretchable design, wherein in addition to the inner side strand, an additional elastic strand, which is likewise in contact with the inner side flank of the said vehicle tire in the mounted state, is provided.

13. The tire chain in accordance with claim 12, wherein the inner side strand and the at least one additional strand are each of a ring-shaped design.

14. The tire chain in accordance with claim 1, wherein the inner side strand is directly connected to the chain net by fastening means, so that tensioning forces generated by the inner side strand are directly introduced into the chain net.

15. The tire chain in accordance with claim 12, wherein the inner side strand is directly connected to the chain net by fastening means, so that tensioning forces generated by the inner side strand are directly introduced into the chain net.
